(19) United States
(12) Patent Application Publication
(10) Pub. No.: US 2002/0006224 A1
(43) Pub. Date: Jan. 17, 2002

(54) Computer automated process for vectorization of raster images

(76) Inventor: Tin Cheung Wong, Kowloon (HK)

Correspondence Address: CLARK & BRODY, Suite 600, 1750 K Street NW, Washington, DC, 20006, US

(21) Appl. No.: 09/900,975

(22) Filed: Jul. 10, 2001

(30) Foreign Application Priority Data
Jul. 14, 2000 (GB) 0017284.1

(51) Int. Cl. G06K 9/48; G06K 9/36

(52) U.S. Cl. 382/199; 382/286

(57) ABSTRACT

A computer automated process for vectorizing raster images to create usable graphic files which can be manipulated by CAD software. The present process makes use of the geometric relationship among the graphic elements contained in the raster image and keeps the graphics elements as a whole during the process of vectorization. The present process not only recognizes the whole line, but also recognizes all the lines intersecting it. The process requires a central processing unit a of a computer programmed with the appropriate instructions to analyze lines found in the bitmap image, together with all intersections and shapes associated with the line in the bitmap image and process that information in accordance with predefined algorithms to create a usable graphic image file. As each line is recognized it is vectorized and it is then deleted from the bitmap image to speed up the process of vectorization.

This invention relates to a computer automated process for vectorizing images, especially drawings from raster files to provide an accurate graphic representation of the image which can then be used and manipulated.

All engineering projects result in the creation of drawings. These drawings are sometimes prepared by computer aided drafting techniques resulting in electronic graphics files. Generally however drawings are prepared using pencil and paper. Electronically prepared drawings files have considerable advantages over paper drawings in that they are easier to store, retrieve and modify. They can be revised in a fraction of the time it would take to revise a paper based drawing. There is also the further advantage that they can be copied and distributed much faster than with paper drawings. With the advent of the Internet this is an important consideration.

Thus there has been considerable demand to be able to convert traditional paper drawings into an electronic format which would enable the user to use and manipulate the drawings as well as provide all the other advantages of the electronic format. This conversion is usually achieved by scanning drawings using a scanner to create a raster (bitmap) image of the drawing. Once a drawing has been scanned it can be converted into a usable graphics format by a process of vectorization.

There are numerous vectorization techniques currently in the market, for converting bitmap images to CAD software acceptable graphics formats.

Current vectorization methods can be divided into two classes according to their process namely thinning based and run length encoding (RLE) based. Both of these methods analyze and recognize a vector depending only on the local information related to the vector. Both these methods have problems in dealing with intersecting lines, shorter lines and distorted lines and so it is difficult to determine the direction to trace through the intersection, especially when there is noise at the intersection point. This leads to a large amount of line searching and proper combining algorithm in the post processing algorithms. These techniques are therefore slow. They are further unsatisfactory due to their limited accuracy. These shortcomings have limited the extent to which paper based drawings are converted to electronic graphics files.

The present invention overcomes the disadvantages of the existing methods of vectorizing raster/bitmap images to create usable graphics files.

The present invention is a computer automated process for vectorizing bitmap images whereby a central processing unit analyses lines found in the raster/bitmap image and processes that information in accordance with predefined algorithms to create usable graphics files which can be manipulated by CAD software. The present process makes use of the geometric relationship among the graphics elements contained in the bitmap/raster image and keeps the graphics elements as a whole during the vectorization. In other words the present process not only recognizes the whole line but also recognizes the lines intersecting it. As a result of this the entire vectorization process is speeded up and is also highly accurate.

Most lines in engineering drawings are not isolated lines but intersect with other lines thereby forming a network of lines. In order to read and vectorize the raster image it is necessary to firstly establish a line network i.e. a collection of connected lines in the drawing which express a meaningful component in the drawing. Once the first line in a line network is recognized then all other lines in the line network can be recognized by virtue of the connectivity of those lines within the line network. This is a fundamental step in the vectorization process.

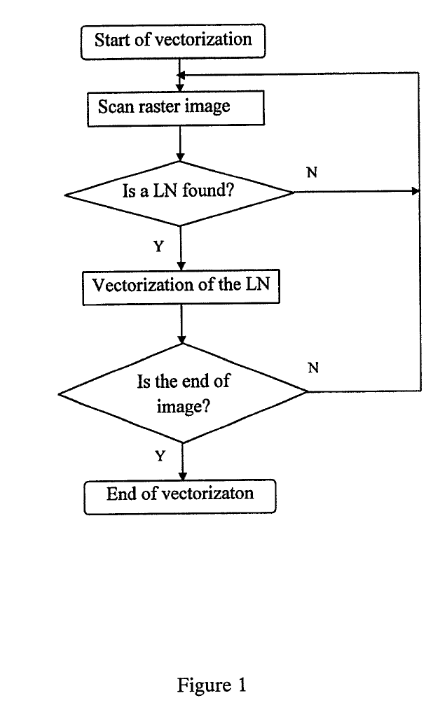

The process of vectorization of an entire drawing is illustrated in the flowchart shown in FIG. 1. The central processing unit scans the raster image to find the first line network. Once a line network is found, it will be recognized completely by global line network vectorization. Then the central processing unit scans the image again for the next line network, until the entire image has been scanned.

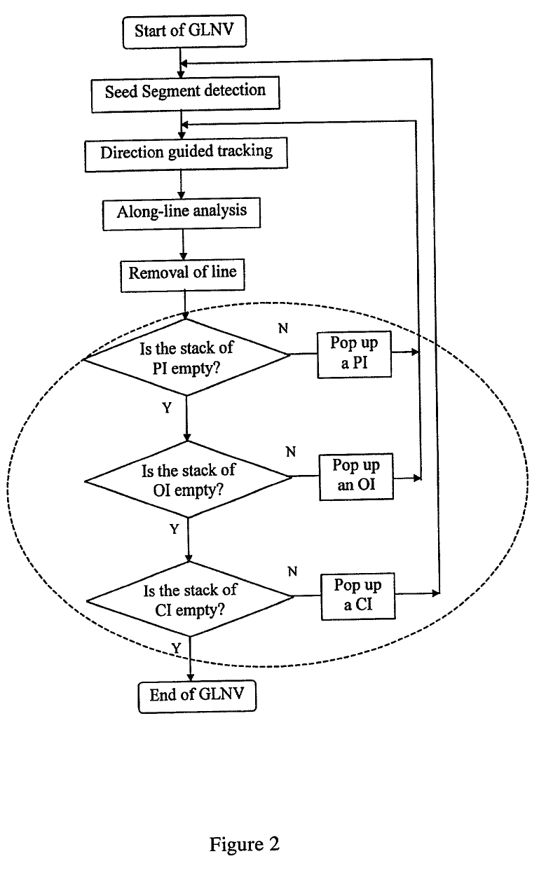

The recognition of a line network is illustrated in the flowchart shown in FIG. 2. Line network recognition is started by firstly establishing a seed segment to get the direction and width of a line. Once a seed segment is recognized, the entire line can then be recognized by growing the seed segment in the two opposite directions. During the recognition of the said line, all intersections along it are also recognized. After the line is recognized, the bitmap corresponding only to it must be deleted from the image data to avoid repetition. Finally, the central processing unit chooses firstly perpendicular intersections (PI), then oblique intersections (OI) and lastly complex intersections (CI) to start the recognition of the intersecting lines using the direction and width detected from that particular intersection. These steps are then repeated in respect of each intersection until the recognition of the entire line network.

Each stage of the process will now be described in detail.

Recognition of a line network starts by first establishing a seed segment. A seed segment is a segment of a line which has no intersections and minimal noise distortion i.e. a regular segment of a line, that features the direction and width of the line.

Starting from the first black pixel encountered, it is possible using a predefined algorithm to ascertain whether any section of the line is within predefined limits such that there are no intersecting lines at that point and the level of noise distortion is at an minimal.

As the first black pixel is encountered by the central processing unit a series of squares, centered at the first black pixel are created. The smallest size of the square is twice the maximum width of the line. If there is a set of adjacent intersections between the bitmaps and the squares which have about the same lengths the central points of the intersections will determine the longer axis of a rectangular area of points which form a seed segment.

In this manner it is possible to identify a section of the line which has no or minimum distortion and no intersecting lines. The longer axis of the seed segment indicates the direction of the line, and the length of shorter axis of seed segment indicates the line width.

Having established a seed segment, the central processing unit then tracks the bitmap image using the Bresenham line converging algorithm to generate point positions on the path of the line, in either direction, to enhance the efficiency. The tracking path starts from the central point of the seed segment along the direction of the long axis of the seed segment and extends in both directions of the line as long as there are black pixels at the path points and the length of perpendicular runs are similar to or longer than the width of seed segment.

If the tracking encounters white pixels then the central processing unit calculates the length of the white segment. If the length of the white segment is greater than a predetermined length then tracking will stop in that direction

For adjusting the line path direction a perpendicular testing algorithm is used. Using the Bresenham algorithm a set of scan lines is generated through the points on the current line path which go through the centre of the seed segment and which are perpendicular to the longitudinal axis of the seed segment. If the perpendicular scan lines are divided by the points equally, then the line path is correct, otherwise the central processing unit will adjust the line path until the correct line path is determined. The scan length of the path is three times the width of the seed segment. After adjusting the line path direction the central processing unit will then track the line to its end point.

Because the direction of tracking is determined, intersections do not affect the tracking of the line from the seed segment. If there is only one black segment on the whole tracking path, it is deemed to be a solid line. If not then the central processing unit analyses the regularity of black and white segments to ascertain if a dashed line exists.

The central processing unit also analyzes the perpendicular runs along the path of a vectorized line to detect intersections on it. An intersecting point is determined if the sizes of the perpendicular runs are continuously more than a threshold value namely the width of the seed segment. The change of the perpendicular size of the intersection varies for different types of intersections. Intersections are classified into three types namely perpendicular intersection, oblique intersection and complex intersection. Perpendicular intersection and oblique intersection indicate a perpendicular intersecting line and an oblique intersecting line respectively. A complex intersection includes other undetermined cases, for example a character or a symbol or something more complex. Details of each type of intersection are stored by the central processing unit in a respective First-In-Last-Out stack together with the information detected around it.

To avoid the repetitive use of the bitmap that is already vectorized, the bitmap corresponding only to the vectorized line is completely erased from the image as soon as the line has been vectorized.

The central processing unit then analyses the features of the intersection to determine which portion of the bitmap image to erase. By using the result of line analysis those parts of the line having no intersection are completely erased and only those parts which have intersections are left.

If there is a perpendicular intersection or oblique intersection at only one side of the line then the half of the line without intersection is erased to the centre of the line.

If there is a perpendicular intersection or oblique intersection at both sides of the line then the portion of the line to be deleted is determine by contours of the branches at each part of the line. Thus for example if the contour indicates that the line is an oblique line at the top of the line in a left hand direction and an oblique line at the bottom of the line in a right hand direction then the line below the mid point of the first oblique line is erased and the line above the midpoint of the second oblique line is erased.

By erasing the vectorized sections of the line we are left with only the intersections to deal with and each intersection is then processed to produce a line network as described below. The image data is therefore simplified gradually during the vectorization, so that the difficulty of vectorization is decreased.

The central processing unit then checks the all intersection types in the order perpendicular intersection, oblique intersection and lastly complex intersection. At every intersection point the central processing unit tracks the intersecting line in the manner described above.

The priority of each intersection type is assigned based on its efficiency to obtain the direction and width of a line. Perpendicular intersections have the highest priority because the direction and width are already available. Oblique intersections have the second priority because the direction must be detected. Complex intersections have the lowest priority because seed segment detection will have to be performed again. Knowing that an entity may be related to more than one intersections in a line network, this order of priority ensures that an line network will be vectorized in the fastest way.

Where there are no intersecting lines then the vectorization of the line network is completed and the central processing unit resumes scanning the raster image for a new seed segment.

By recognizing the lines and the intersecting lines a line network can be implemented. As a result of recognizing the line networks in a raster image it is possible to vectorize the image thereby creating a graphical image which can be used and manipulated.

The process will now be described by reference to the drawings.

FIG. 1 shows the flowchart of the line network;

FIG. 2 shows a flowchart of the entire line network vectorization;

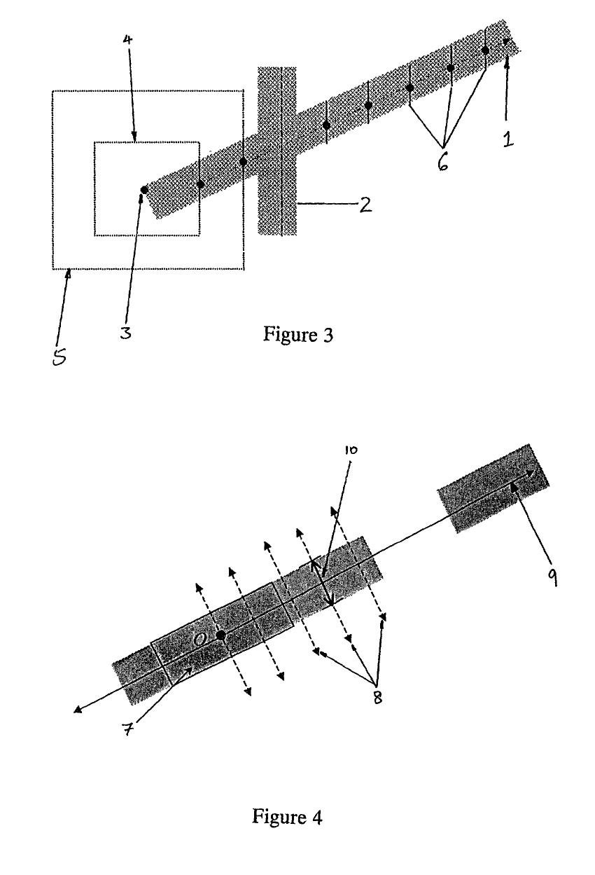

FIG. 3 shows the algorithm to locate the seed segments on a line;

FIG. 4 shows the algorithm for tracking the line path;

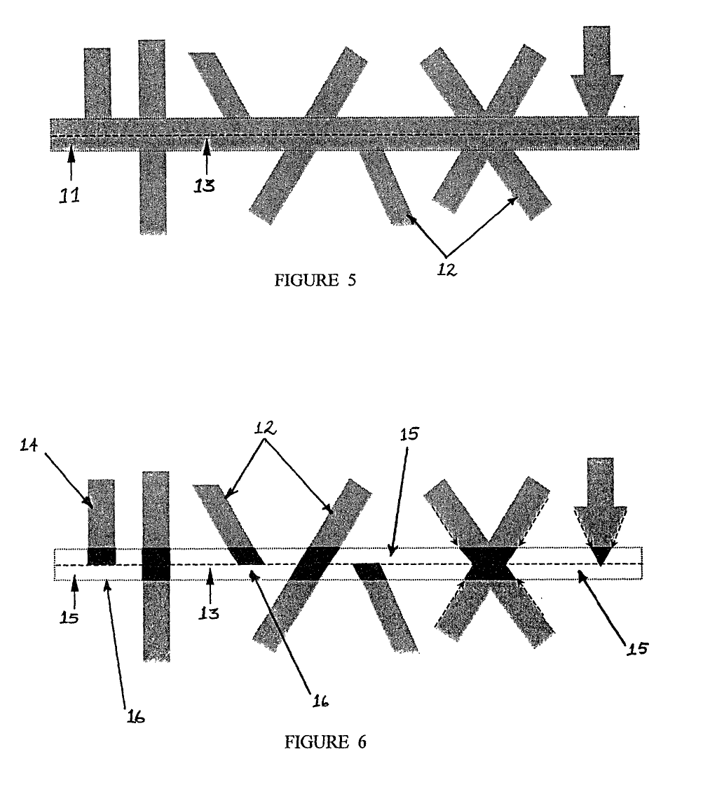

FIG. 5 shows a line with various intersections;

FIG. 6 shows the line once the vectorized portions of the line have been deleted;

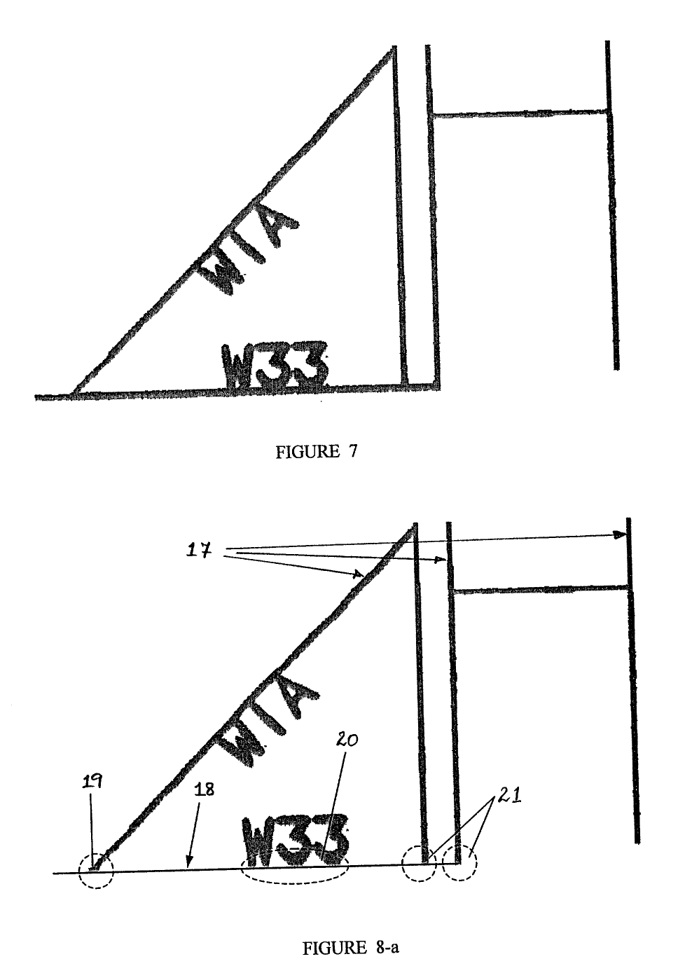

FIG. 7 shows a simple line network in the bitmap image.

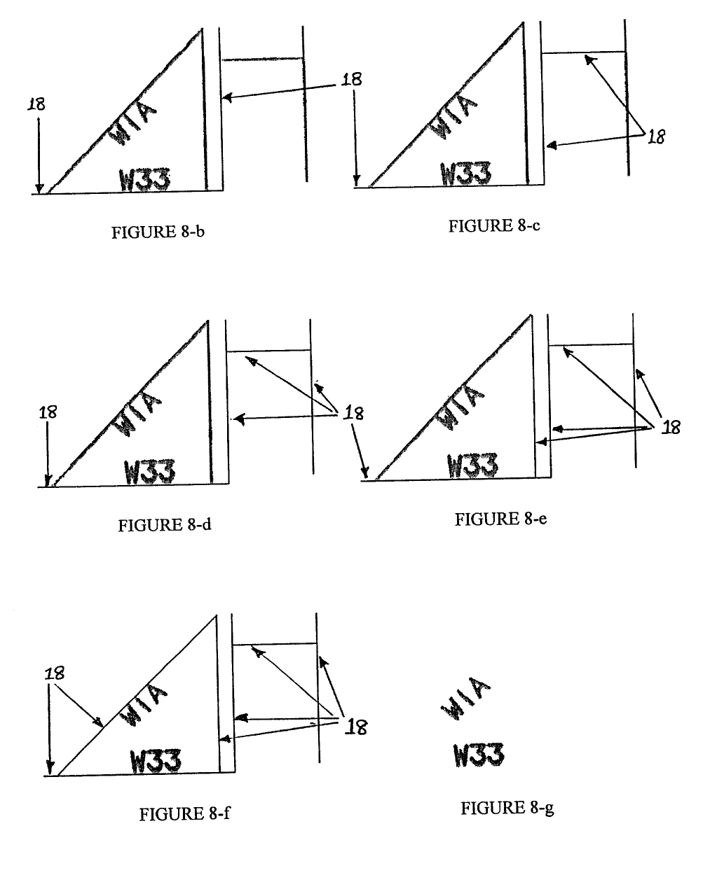

FIG. 8a-g shows the result of vectorization of the first line in the line network and each type of intersection detected along this line.

FIG. 3 shows an enlarged portion of an oblique line (1) with a vertical line (2). At the first black pixel (3) a series of squares (4) and (5) are generated by the central processing unit. The size of the smallest square (4) is twice the width of the line (1). If the central processing unit determines that there is a set of adjacent intersections between the bitmap and the squares which have the same or approximately the same lengths (6) then the central points of the intersections will determine the longer axis of a rectangular area of points which will form the seed segment.

FIG. 4 shows a seed segment (7) which has been determined by the central processing unit in accordance with the above process. A set of scan lines (8) which are perpendicular to the longitudinal axis of the seed segment are generated by the central processing unit along the current line path (9). If the perpendicular runs (10) are divided by the points equally then the line path is deemed to be correct.

FIG. 5 shows a line (11) that has been recognized. Various intersections (12) in the line are detected and the central processing unit then further analyses these intersections to determine the type of intersection it is. The central axis of the line (13) is determined by the central processing unit to further analyze the intersections.

Once the line has been recognized then it be seen from FIG. 6 that the portions of the line that have been recognized and which have no intersections (15) are erased. Where there are intersections (12) then the appropriate portion of the recognized line is erased depending on the type of the intersection and whether the intersection is on one or both sides of the central axis (13) of the line. Where the intersection is only on one side of the recognized line (14) then the area below that line is erased (16) following the contours of the intersection.

FIG. 7 shows the result of vectorization of the first line in the line network and each type of intersection detected along this line.

FIG. 8a shows the gray lines (17) are raster image and the black line at the bottom (18) is the vectorized line with its corresponding bitmap erased. Various intersection points (19, 20 and 21) are found along the vectorized line being an oblique intersection, a complex intersection and perpendicular intersection respectively.

FIG. 8-b to 8-f show the vectorization of every successive lines (18) in order. This order is determined by the order of intersections being pushed into the stacks.

FIG. 8-g shows that once the lines in the bitmap image have been recognized, the bitmap corresponding to lines will be erased from the image. On this basis, the symbols and character strings could be recognized in accordance with predefined algorithms without the interfering of lines.

1. A computer automated process for complete vectorization of bitmap images wherein the central processing unit of a computer programmed with the appropriate instructions analyses the lines in the bitmap images, intersections and shapes associated with the lines in the bitmap image and processes the same sequentially in accordance with predefined algorithms to create a complete vectorized image of the lines together with all intersections and shapes associated with those lines.

2. A computer automated process as claimed in claim 1 above wherein the central processing unit sequentially analyses in accordance with a predefined algorithm each black pixel in the bitmap image to determine a segment of a line which has no intersections and wherein the distortion due to noise is within predefined limits.

3. A computer automated process as claimed in claim 2 above wherein the central processing unit scans the segment of line from the first black pixel which has no intersections and wherein the distortion due to noise is within predefined limits in each direction of the line and wherein the position, length and direction of the line is determined in accordance with a predefined algorithm and wherein the position, length and direction of the line is then converted to a vector to create a vectorized image of the line corresponding with the bitmap image.

4. A computer automated process as claimed in claim 3 above wherein the central processing unit analyses all intersecting lines detected along the line in accordance with a predefined algorithm and wherein the direction, position and length of the intersecting lines are determined in accordance with a predefined algorithm and wherein the direction, position and length of the intersecting lines is then converted to a vector to create a vectorized image of the intersecting lines corresponding with the bitmap image.

5. A computer automated process as claimed in claim 4 above wherein all lines and intersections associated with that line detected by the central processing unit from the bitmap image are deleted from the bitmap image once they have been vectorized by the central processing unit and wherein the central processing unit then repeats the entire process as claimed hereinabove to vectorize all subsequent lines and intersecting lines.
